(19) United States
(12) Patent Application Publication
(10) Pub. No.: US 2006/0119998 A1
(43) Pub. Date: Jun. 8, 2006

(54) Electrostatic discharge protection circuit, display panel, and electronic system utilizing the same

(76) Inventors: Sheng-Chieh Yang, Taoyuan City (TW); An Shih, Puyan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/298,908

(22) Filed: Dec. 9, 2005

Related U.S. Application Data
(63) Continuation-in-part of application No. 10/841,158, filed on May 7, 2004.

(51) Int. Cl. H02H 9/00

(52) U.S. Cl. 361/56

(57) ABSTRACT

An electrostatic discharge (ESD) protection circuit. A first PMOS transistor includes a first gate, a first source coupled to the first gate and a first power line, and a first drain coupled to a pad. A second PMOS transistor includes a second gate, a second source coupled to the second gate and the pad, and a second drain coupled to a second power line. A ESD detection circuit outputs an enable signal when an ESD event occurs in the first power line. A discharge device provides a discharge path between the first and second power lines when receiving the enable signal.

### BACKGROUND

This application is a continuation-in-part of U.S. application Ser. No. 10/841,158, filed May 7, 2004, now examined.

The disclosure relates to a protection circuit, and more particularly to an electrostatic discharge (ESD) protection circuit.

With the evolution of semiconductor manufacturing, ESD protection has become one of the most critical reliability issues for integrated circuits (IC). Several ESD test modes, such as machine mode (MM) or human body mode (HBM), have been proposed to imitate the circumstances under which ESD occurs. The ability to withstand certain levels of ESD is essential for successful commercialization of an IC.

ESD protection is also a critical reliability issues for integrated circuits (IC). In particular, as the semiconductor process advances into the deep sub-micron stage, scaled-down devices and thinner gate oxides are more vulnerable to ESD stress. Generally, the input/output pads on IC chips must sustain at least 2 kVolt ESD of high stress in Human Body Mode (HBM) or 200V in Machine Mode. Thus, the input/output pads on IC chips usually include ESD protection devices or circuits protecting the core circuit from ESD damage.

FIG. 1 is a schematic diagram of conventional ESD protection circuit. Conventional ESD protection circuit 1 comprises a PMOS transistor 13 and a NMOS transistor 14.

PMOS transistor 13 has a gate and a source coupled to power line 11 and a drain coupled to PAD 16 and core circuit 18. NMOS transistor 14 has a gate and a source coupled to power line 12 and a drain coupled to PAD 16 and core circuit 18.

When power line 12 is grounded and positive ESD voltage sufficiently turning on NMOS transistor 14 is applied to PAD 16, ESD current flows through PAD 16, NMOS transistor 14, and finally to power line 12.

Since conventional ESD protection circuit comprises two type transistors, when conventional ESD protection circuit is integrated into a display device, processes of fabrication and mask are increased.

### SUMMARY

Electrostatic discharge protection circuits and display devices utilizing the same are provided. An exemplary embodiment of an electrostatic discharge (ESD) protection circuit comprises a first PMOS transistor, a second PMOS transistor, an ESD detection circuit, and a discharge device. The first PMOS transistor comprises a first gate, a first source coupled to the first gate and a first power line, and a first drain coupled to a pad. The second PMOS transistor comprises a second gate, a second source coupled to the second gate and the pad, and a second drain coupled to a second power line. The ESD detection circuit is coupled between the first and second power lines, for outputting an enable signal when an ESD event occurs in the first power line. The discharge device comprises a control terminal coupled to the ESD detection circuit, a first electrode coupled to the first power line, and a second electrode coupled to the second power line, for providing a discharge path between the first and second power lines when the control terminal receives the enable signal.

Display devices with ESD protection circuit are also provided. An exemplary embodiment of a display device with ESD protection circuit comprises a gate driver, a data driver, a pixel area, and an ESD protection circuit. The gate driver provides a plurality of scan signals to a plurality of gate electrodes. The data driver provides a plurality of data signals to a plurality of data electrodes. The pixel area comprises a plurality of pixel units respectively connected to corresponding data lines and corresponding gate lines. The ESD protection circuit comprises a first PMOS transistor, a second PMOS transistor, an ESD detection circuit, and a discharge device. The first PMOS transistor comprises a first gate, a first source coupled to the first gate and a first power line, and a first drain coupled to a pad. The second PMOS transistor comprises a second gate, a second source coupled to the second gate and the pad, and a second drain coupled to a second power line. The ESD detection circuit is coupled between the first and second power lines, for outputting an enable signal when an ESD event occurs in the first power line. The discharge device comprises a control terminal coupled to the ESD detection circuit, a first electrode coupled to the first power line, and a second electrode coupled to the second power line, for providing a discharge path between the first and second power lines when the control terminal receives the enable signal.

### BRIEF DESCRIPTION OF THE DRAWINGS

The invention can be more fully understood by reading the subsequent detailed description and examples with reference made to the accompanying drawings, wherein:

FIG. 1 is a schematic diagram of conventional ESD protection circuit;

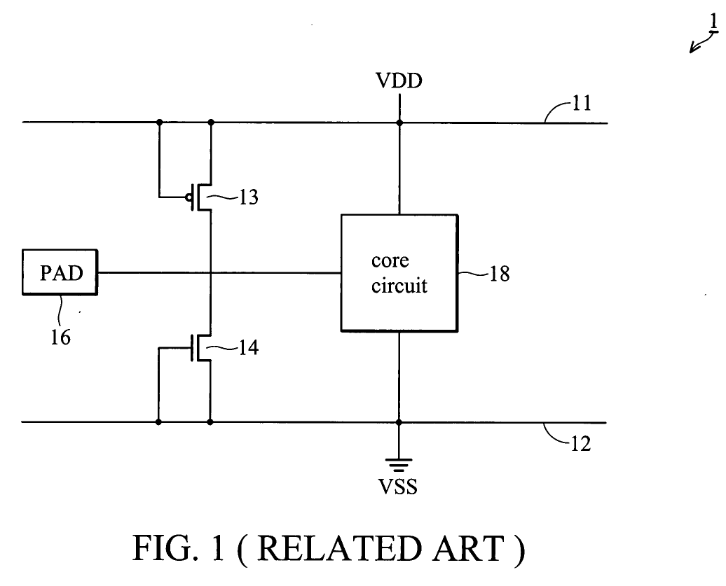

FIG. 2a is a schematic diagram of an embodiment of an electronic system

FIG. 2b is a schematic diagram of an embodiment of a display device;

FIG. 3 is a schematic diagram of an embodiment of an ESD protection circuit;

FIG. 4 is a schematic diagram of an embodiment of an ESD protection circuit.

### DETAILED DESCRIPTION

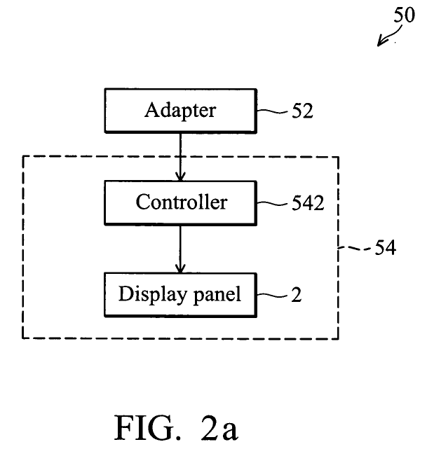

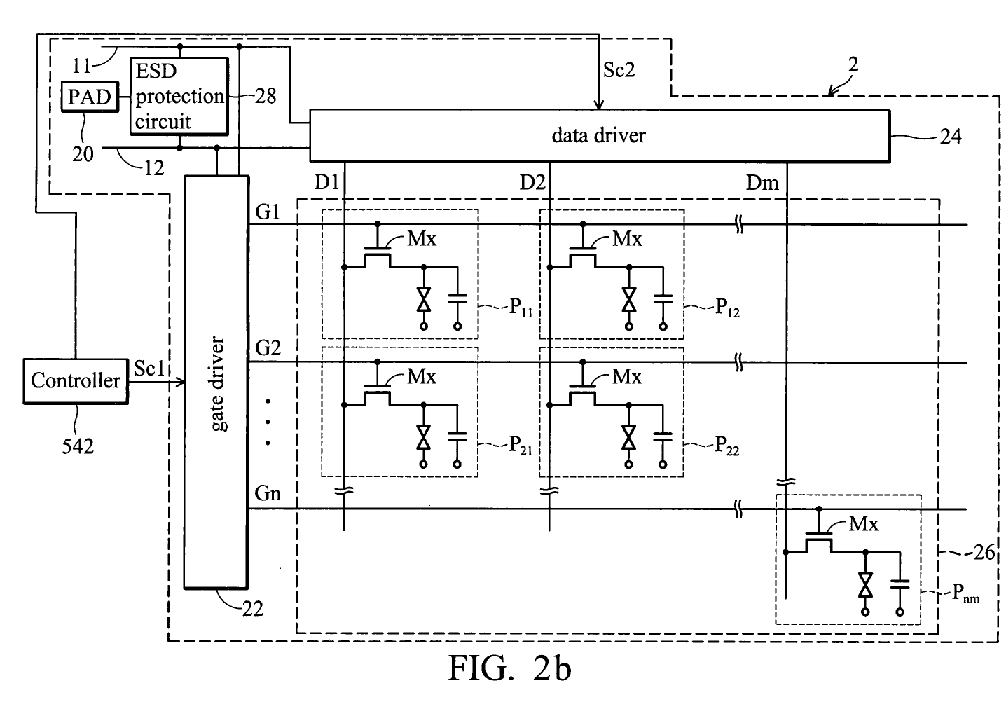

FIG. 2a is a schematic diagram of an embodiment of an electronic system. Electronic system 50, such as a PDA, a notebook computer, a tablet computer, or a cellular phone, comprises an adapter 52 and a display device 54. Adapter 52 supplies power and drives display device 54. Display device 54 comprises a controller 542 and a display panel 2. Controller 542, such as a timing controller, controls display panel 2 for displaying image.

FIG. 2b is a schematic diagram of an embodiment of a display device. The display device 2 comprises a gate driver 22, a data driver 24, a pixel area 26, and an ESD protection circuit 28. Controller 542 provides a control signal Sc1 to gate driver 22 and a control signal Sc2 to data driver 24.

Gate driver 22 provides scan signals to gate electrode G1˜Gn according to the control signal Sc1. Data driver 24 provides data signals to data electrode D1˜Dm according to the control signal Sc2. Pixel area 26 comprises pixel units P₁₁˜Pₙₘ respectively connected to corresponding data lines and corresponding gate lines. Transistors of pixel units P₁₁˜Pₙₘ are low temperature poly silicon (LTPS) transistors. ESD protection device 28 is coupled to PAD 20 and coupled between power line 11 and power line 12.

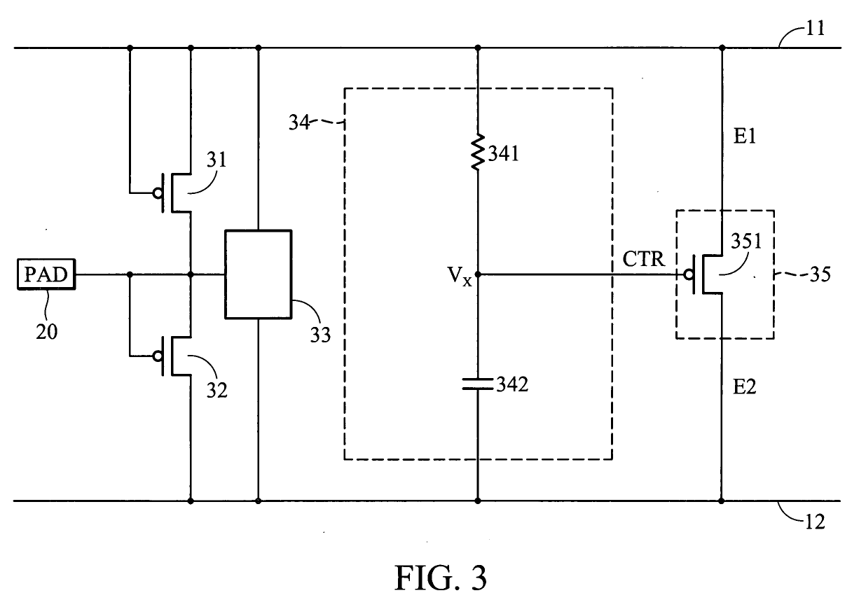

FIG. 3 is a schematic diagram of an embodiment of an ESD protection circuit. ESD protection circuit 28 comprises PMOS transistors 31, 32, an ESD detection circuit 34, and a discharge device 35.

PMOS transistor 31 has a source and a gate coupled to power line 11 and a drain coupled to PAD 20 and core circuit 33. PMOS transistor 32 has a source and a gate coupled to PAD 20 and core circuit 33 and a drain coupled to power line 12.

PMOS transistors 31 and 32 protect core circuit 33 against potential damage from ESD current from PAD 20. When power line 12 is grounded and sufficient positive ESD voltage turning on PMOS transistor 32 is applied to PAD 20, beginning at PAD 20, ESD current is discharged through PMOS transistor 32 to power line 12.

ESD detection circuit 34 is coupled between power lines 11 and 12, when an ESD event occurs in power line 11, ESD detection circuit 34 outputs an enable signal. Discharge device 35 has a control terminal CTR coupled to ESD detection circuit 34, an electrode E1 coupled to power line 11, and an electrode E2 coupled to power line 12. When discharge device 35 receives the enable signal, providing a discharge path for dissipating ESD current.

ESD detection circuit 34 and discharge device 35 avoid that core circuit 33 suffers an ESD pulse from power line 11. When an ESD pulse is occurs in power line 11 and power line 12 is grounded, ESD current is dissipated by discharge device 35.

ESD detection circuit 34 comprises resistor 341 and capacitor 342. A first terminal of resistor 341 is coupled to power line 11 and that of capacitor 342 is coupled to power line 12. A second terminal of resistor 342 is coupled to a second terminal of capacitor 342. Resistor 341 and capacitor 342 define a delay constant. The delay constant exceeds the duration of an ESD pulse and is less than the initial rising time of a signal, wherein the signal is received by power line 11.

Discharge device 35 can be a PMOS transistor 351 comprising a gate coupled to the second terminal of resistor 341, a source coupled to power line 11, and a drain coupled to power line 12.

When an ESD pulse occurs in power line 11 and power line 12 is grounded, since the delay constant defined by resistor 341 and capacitor 342 exceeds the duration of the ESD pulse, point Vₓ maintains low voltage level turning on PMOS transistor 351. Therefore, ESD current flows through power line 11, PMOS transistor 351, and finally to power line 12.

Since the delay constant is less than the initial rising time of the signal, as display device 2 is in a normal mode, a voltage of point Vₓ almost equals the voltage of the signal turning off PMOS transistor 351.

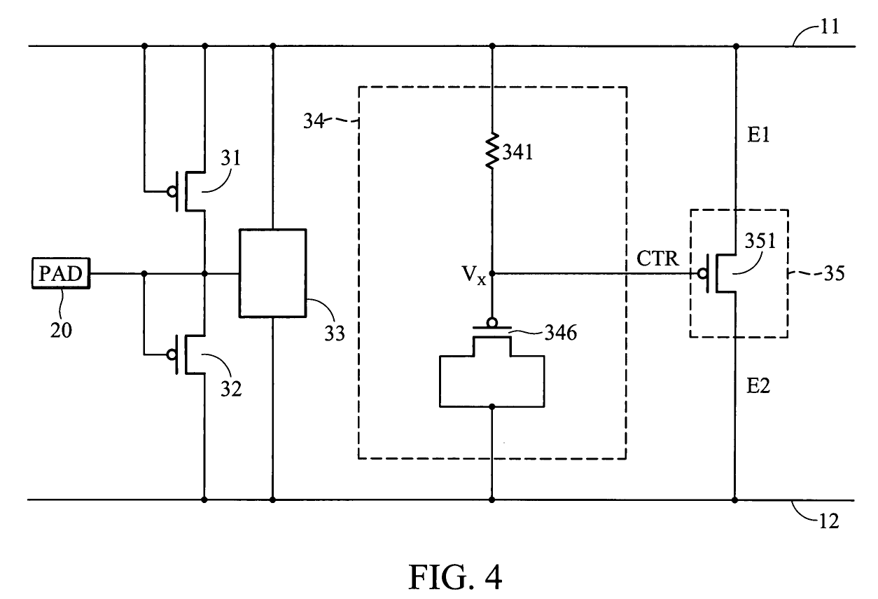

FIG. 4 is a schematic diagram of an embodiment of an ESD protection circuit. FIG. 4 is similar to the FIG. 3 with the exception that capacitor 342 is formed by a PMOS transistor 346 having a gate coupled to resistor 341 and a drain and a source coupled to power line 12.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrostatic discharge (ESD) protection circuit comprising:
a first PMOS transistor comprising a first gate, a first source coupled to the first gate and a first power line, and a first drain coupled to a pad;
a second PMOS transistor comprising a second gate, a second source coupled to the second gate and the pad, and a second drain coupled to a second power line;
an ESD detection circuit outputting an enable signal when an ESD event occurs in the first power line; and
a discharge device providing a discharge path between the first and second power lines when receiving the enable signal.

2. The electrostatic discharge protection circuit as claimed in claim 1, wherein the discharge device is a P-type thin film transistor with a gate receiving the enable signal, a source coupled to the first power line, and a drain coupled to the second power line.

3. The electrostatic discharge protection circuit as claimed in claim 1, wherein the ESD detection circuit comprises:
a resistor having a first terminal coupled to the first power line; and
a capacitor having a first terminal coupled to the second power line and a second terminal coupled to a second terminal of the resistor.

4. The electrostatic discharge protection circuit as claimed in claim 3, wherein the discharge device is a first P-type thin film transistor with a gate coupled to the second terminal of the resistor, a source coupled to the first power line, and a drain coupled to the second power line.

5. The electrostatic discharge protection circuit as claimed in claim 4, wherein the capacitor is a second P-type thin film transistor with a gate coupled to the second terminal of the resistor, a source coupled and a drain coupled to the second power line.

6. A display device comprising:
a gate driver providing a plurality of scan signals to a plurality of gate electrodes;
a data driver providing a plurality of data signals to a plurality of data electrodes;
a pixel area comprising a plurality of pixel units respectively connected to corresponding data lines and corresponding gate lines; and
an electrostatic discharge protection circuit comprising:
a first PMOS transistor comprising a first gate, a first source coupled to the first gate and a first power line, and a first drain coupled to a pad;
a second PMOS transistor comprising a second gate, a second source coupled to the second gate and the pad, and a second drain coupled to a second power line;
an ESD detection circuit outputting an enable signal when an ESD event occurs in the first power line; and
a discharge device providing a discharge path between the first and second power lines when the control terminal receives the enable signal.

7. The display device as claimed in claim 6, wherein the discharge device is a P-type thin film transistor with a gate receiving the enable signal, a source coupled to the first power line, and a drain coupled to the second power line.

8. The display device as claimed in claim 6, wherein the ESD detection circuit comprises:
a resistor having a first terminal coupled to the first power line; and
a capacitor having a first terminal coupled to the second power line and a second terminal coupled to a second terminal of the resistor.

9. The display device as claimed in claim 8, wherein the discharge device is a first P-type thin film transistor with a gate coupled to the second terminal of the resistor, a source coupled to the first power line, and a drain coupled to the second power line.

10. The display device as claimed in claim 9, wherein the capacitor is a second P-type thin film transistor with a gate coupled to the second terminal of the resistor, a source and a drain coupled to the second power line.

11. The display device as claimed in claim 6, wherein the display area is formed with a plurality of low temperature poly silicon (LTPS) transistors.

12. The display device as claimed in claim 6, further comprising a controller for controlling the gate driver and the data driver.

13. The display device as claimed in claim 12, the controller is a timing controller.

14. An electronic system comprising:
a display device as claimed in claim 12; and
an adapter driving the display device.

15. The electronic system as claimed in claim 14, wherein the electronic system is a PDA, a notebook computer, a tablet computer, or a cellular phone.
